(19) United States
(12) Patent Application Publication
(10) Pub. No.: US 2003/0056057 A1
(43) Pub. Date: Mar. 20, 2003

(54) System and method for power reduction of memory

(76) Inventor: Richard H. Lawrence, Hudson, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/957,428

(22) Filed: Sep. 19, 2001

(51) Int. Cl. G06F 12/00

(52) U.S. Cl. 711/106

(57) ABSTRACT

A system or memory to support an adjustable frequency of a memory based at least in part on the sensed temperature of the memory.

### DESCRIPTION OF THE RELATED ART

The demand for more powerful computers and communication products has resulted in faster processors that often consume increasing amounts of power. However, design engineers struggle with reducing power consumption, for example, to prolong battery life, particularly in mobile and communication systems.

A Dynamic Random Access Memory, DRAM, is a typical memory to store the previously described information types. DRAMs contain a memory cell array having a plurality of individual memory cells; each memory cell is coupled to one of a plurality of sense amplifiers, bit lines, and word lines. The memory cell array is arranged as a matrix of rows and columns, and the matrix is further subdivided into a number of banks.

The DRAM memory cell consists of a single transistor and a single capacitor and is dynamic because charge stored on the capacitor decays because of a various leakage current paths to surrounding cells and to the substrate. Typically, a refresh operation is performed on the DRAM memory cell to ensure the validity of the data. For example, the refresh operation is initiated by a memory controller to read the data from the cell array via the sense amplifiers and subsequently rewriting the data back into the cell array. Thus, the refresh operation restores the capacitor's charge to ensure the validity of the data. One typical refresh operation is a normal distributed refresh wherein a memory controller issues periodic refresh operations to refresh a memory row.

Another typical refresh operation that is supported by Synchronous Dynamic Random Access Memories (SDRAMs) is a self-refresh, which is a refresh operation executed by the SDRAM rather than the memory controller. During the self-refresh, the SDRAM utilizes an internal oscillator to generate refresh cycles to maintain the data in the memory cells. A worst-case scenario at the highest operating temperature determines the self-refresh operation's frequency. Presently, a low power SDRAM is capable of adjusting the self-refresh frequency. However, prior art systems are not capable of supporting the adjustable self-refresh frequency.

Utilizing a worst-case scenario for selecting a self-refresh frequency, however, limits the choice of frequencies because the scenario only considers a single temperature. A negative to consequence of such an approach is higher power consumption. For example, higher power consumption may adversely affect battery life in mobile systems, such as cell phones, personal digital assistants (PDAs), laptops, and other systems. The use of a self-refresh frequency based on the worst-case scenario may, therefore, reduce the battery life of mobile devices and limit design flexibility.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a schematic diagram of a computing system in accordance with one embodiment.

FIG. 2 is a register in accordance with one embodiment.

FIG. 3 is a schematic diagram of a computing system in accordance with one embodiment.

FIG. 4 is a schematic diagram of a computing system in accordance with one embodiment.

FIG. 5 is a schematic diagram of a network in accordance with one embodiment.

### DETAILED DESCRIPTION

A system and a method for adjusting the self-refresh frequency of a memory are described. In the following description, for purposes of explanation, numerous details are set forth in order to provide a thorough understanding of the claimed subject matter. However, it will be apparent to one skilled in the art that these specific details are not required in order to practice the claimed subject matter.

An area of current technological development relates to achieving longer battery life for communication products and computer or computing systems by reducing power consumption. As previously described, systems do not support the adjustable refresh frequency of SDRAMs. Utilizing the worst-case scenario for selecting the refresh frequency, however, limits the choice of frequencies because the scenario only considers a single temperature. A negative consequence of such an approach is higher power consumption. In contrast, an adjustable refresh frequency to support and facilitate adjusting frequencies for different temperatures will reduce power consumption. Thus, implementing a more efficient method and system to support the adjustable self-refresh or normal distributed refresh is desirable.

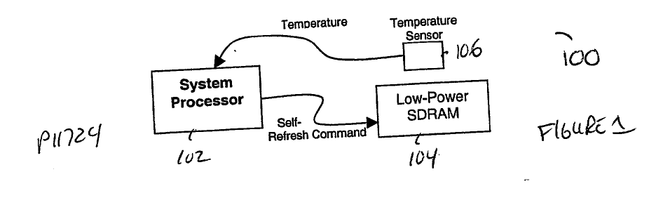

FIG. 1 is a schematic diagram of a computing system in accordance with one embodiment. The system 100 includes, but is not limited to, a processor 102, a memory 104, and a temperature sensor 106. In one embodiment, the memory is a single low-power synchronous dynamic random access memory. In another embodiment, there is a plurality of memories, and at least one of the memories is a low-power synchronous dynamic random access memory. The system may comprise, for example, a personal computer system, a personal digital assistant (PDA), a cellular phone, or an Internet communication device, such as, a web tablet. Of course, these are merely examples and the claimed subject matter is not limited in scope to these examples. The claimed subject matter can also support wireless or wired products, which is discussed further in connection with FIG. 5.

Although the scope of the claimed subject matter is not limited in this respect, it is noted that some embodiments may include subject matter from the following co-pending applications: a first patent application with a serial number of ______, and with a Title of “A System and Method for Power Reduction”, attorney docket P11726 and with the inventor Richard H. Lawrence; and a second patent application with a serial number of ______, and with a Title of “A System and Method for Managing Data in Memory for Reducing Power Consumption”, attorney docket P11725 and with the inventor Richard H. Lawrence.

System 100 monitors the temperature with the temperature sensor 106. In one -embodiment, the temperature sensor monitors and calculates the temperature sensed and forwards it to the processor. The temperature sensor may be integrated into the processor, for example, the sensor may be incorporated into the processor's design and manufactured as part of the processor, although the subject matter is not limited in scope in this respect. Alternatively, the temperature sensor may be physically attached to the processor's package. Another embodiment may include a plurality of temperature sensors attached internally or externally to the processor with an average temperature calculated using measurements from the plurality of temperature sensors. In yet another example, the temperature sensor may be located on or near the system board, such as within several centimeters, and the temperature is extrapolated from the sensors' readings.

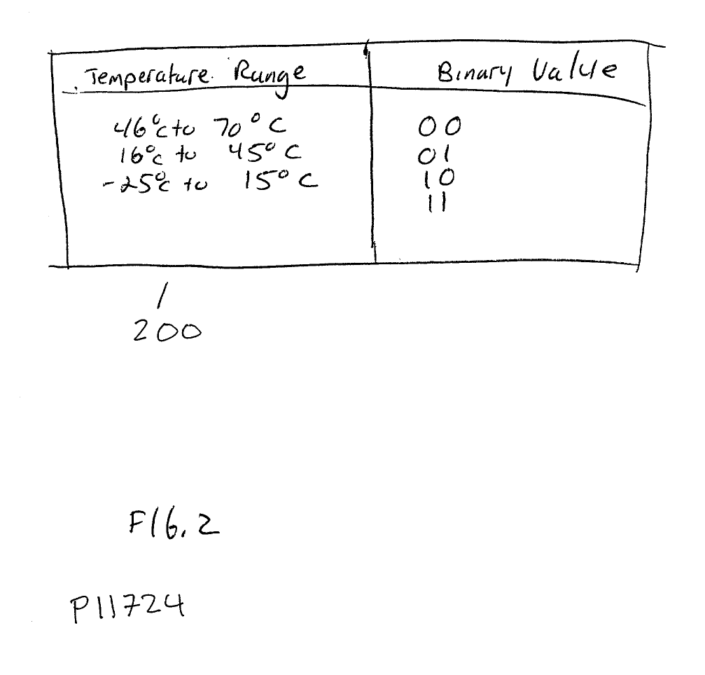

The processor upon receiving the temperature from at least one temperature sensor as illustrated in the multiple embodiments discussed in the preceding paragraph, may determine the refresh frequency. As one example, the processor may analyze the sensed temperature and searches a set of data based at least in part on the sensed temperature. One example of the set of data is the values listed in FIG. 2 that depicts a two-bit value stored in a register for a plurality of temperature ranges as defined by Joint Electronic Device Engineering Council (JEDEC).

Processor 102 may adjust the self-refresh or normal distributed frequency based at least in part on the sensed temperature and the values in FIG. 2 by issuing a refresh command to the memory 104. In one embodiment, the refresh command includes, but is not limited to, the processor writing a two-bit value into an extended mode register of the memory to correlate to the sensed temperature and the set of data in FIG. 2. Each two-bit value in FIG. 2 corresponds to a different temperature range. For example, in one embodiment the two-bit value of binary “00” indicates a temperature range of 46° C. to 70° C.; a binary “01” value is for a range of 16° C. to 45° C.; a binary “10” values is for a range of −25° C. to 15° C.; and a binary “11” value is for a range of 71° C. to 85° C. Of course, the invention is not limited to four temperature ranges. One skilled in the art appreciates utilizing a different number of temperature ranges or utilizing more than two bits to store the temperature ranges.

For example, assume the temperature sensor is presently sensing a 40° C. temperature and transmits the sensed temperature to the processor. In one embodiment, the processor may write a binary “01” value into the register to correlate to the sensed temperature of 40° C. and the corresponding temperature range in FIG. 2. Alternatively, an extended mode register set cycle is used to write at least two bits of the extended mode register with an address bit during a power-up cycle or during a normal operating cycle. Thus, for both preceding embodiments the memory's refresh frequency may be lowered based at least in part to the memory's sensed temperature. Therefore, at least in one instance the claimed subject matter is distinguishable from the worst-case scenario in that the claimed subject matter allows for flexible and efficient adjustment of refresh frequency at various temperatures.

System 100 is capable of providing an adjustable refresh frequency to the memory 104 based at least in part on the operating temperature of the memory. Of course, the claimed subject matter is not limited in this respect. For example, the refresh frequency may be based on the temperature and additional factors such as the type of application (military or consumer) and the number of additional memories and their respective temperatures. Likewise, the system may have a plurality of memories and the temperature is individually calculated for each memory, or calculated based on the average of at least a few of the memories' temperatures. Also, one skilled in the art appreciates utilizing more than a two-bit value to allow for more temperature ranges, or using a one-bit value for two temperature ranges.

The claimed subject matter supports the adjustable refresh frequency of low power synchronous dynamic random access memories. However, the claimed subject matter is not limited to this storage mechanism or to refresh operations. For example, the claimed subject matter is flexible to support memory devices with adjustable frequencies.

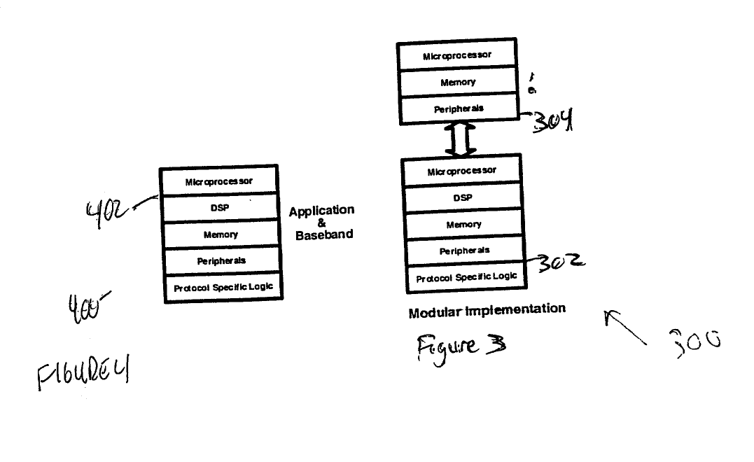

In one embodiment, the claimed subject matter is incorporated into a communication or wireless device and/or implemented with Intel® XScale™ micro architecture and Intel® Personal Internet Client Architecture (Intel® PCA) and is discussed further in FIGS. 3, 4, and 5.

FIG. 3 is a schematic diagram of a computing system in accordance with one embodiment. The schematic represents a flexible design implementation for communication products. In one embodiment for a single processor, logic blocks 302 and 304 represents a modular process wherein the communication processor and application processor may be logically separated. Thus, only one communication processor may be employed for a wireless protocol, and one application processor for a set of applications.

The communication processor 302 is designed for a particular wireless protocol. For example, the protocol specific logic is designed for a plurality of existing wireless standards such as personal digital cellular (PCS), personal digital cellular (PDC), global system for mobile communications (GSM), time division multiple access (TDMA), and code division multiple access (CDMA). The protocol specific logic can support a variety of standards such as IS-136, IS-95, IS-54, GSM1800 and GSM1900.

Communication processor 302 comprises, but is not limited to, a digital signal processor (DSP), a microprocessor, and memory, and peripherals. The application processor 304, comprises, but is not limited to, a microprocessor, memory and peripherals. The application processor may be general purpose and re-programmable. Also, it is capable of executing native binaries in the system, or from another communication product, or from a network. Thus, the application processor is coupled to the communication processor and is logically separated. Therefore, each processor can be developed in parallel rather than the typical serial process.

In one embodiment, the communication processor and application processor may be manufactured on a silicon wafer. However, the processors may operate independently and may have different operating systems. In another embodiment, the communication processor and application processor may be coupled to a common memory controller, which in turn may be coupled to a common memory. Alternatively, each processor may integrate their respective memories. For example, processors may have memory residing on the processor die, rather than having a separate memory. Examples of various memories that may be integrated into each processor are flash memory, static random access memory, and dynamic random access memory.

Although the subject matter is not limited in scope in this respect, Intel® XScale™ micro architecture and Intel® Personal Internet Client Architecture (Intel® PCA) may support a modular implementation as illustrated in FIG. 3. Also, the architectures may support a variety of features, such as a browser to access Internet content and applications, a user interface for allowing interaction with content and applications that include speech, graphics, video, and audio. The architectures may have a file system to manage and protect access to applications, communications, and network code. The architectures may allow for radio interface to transmit and receive from a wireless carrier or service bearer. Further, the architectures may allow for system management for the application processor's operating system kernel, user applications, and the communications processor's real time operating system functions, and content or data payload. Of course, the claimed subject matter is not limited in this respect.

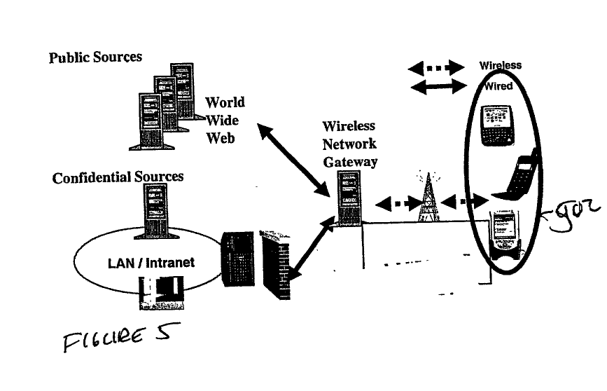

FIG. 4 is a schematic diagram of a computing system in accordance with one embodiment. The block diagram 402 illustrates an integrated implementation of an application and communication processor. In one embodiment, block diagram 402 is utilized in a system with multiple processors. The block diagram comprises, but is not limited to, a digital signal processor (DSP), a microprocessor, and memory, peripherals, a microprocessor, memory, and peripherals. In one aspect, FIG. 4 differs from FIG. 3 in that a single integrated logic processor 402 supports both the application and communication functions. In contrast, FIG. 3 is a modular design and illustrates two processors to individually support either the communication or application functions.

Although the subject matter is not limited in scope in this respect, Intel® XScale™ micro architecture and Intel® Personal Internet Client Architecture (Intel® PCA) may support an integrated implementation as illustrated in FIG. 4. Also, the architectures may support a variety of features, such as a browser to access Internet content and applications, a user interface for allowing interaction with content and applications that include speech, graphics, video and audio. The architectures may have a file system to manage and protect access to applications, communications, and network code. The architectures may allow for radio interface to transmit and receive from a wireless carrier or service bearer. Further, the architectures may allow for system management for the application processor's operating system kernel, user applications, and the communications processor's real time operating system functions, and content or data payload. Of course, the claimed subject matter is not limited in this respect.

FIG. 5 is a schematic diagram of a network in accordance with one embodiment. In one embodiment, the previously described system for reducing power consumption in FIG. 2 and the modular implementation for communication products and architectures described in FIGS. 3 and 4 may be implemented in various communication products as depicted in FIG. 5. For example, the communication products may include, but is not limited to, Internet tablets, cellular phones, personal digital assistants, pagers, and personal organizers. Also, the communication products may receive information via a wired or wireless connection.

Of course, the claimed subject matter is not limited in this respect. For example, one skilled in the art will appreciate the claimed subject matter may also include systems that provide low power consumption and use batteries as a power source. Alternatively, the claimed subject matter may also include a system or boards that employ thermal dissipation. One example includes a rack-mount of servers with multiple boards plugged into rack-mounted enclosures. The boards are closely spaced and may consume large amounts of power. Therefore, the claimed subject matter may improve the thermal dissipation by reducing the power consumption.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1. A system comprising:
a processor;
a dynamic memory having an adjustable refresh frequency; and
at least one temperature sensor, coupled to the dynamic memory, to sense the dynamic memory's temperature, the processor to adjust the refresh frequency of the dynamic memory based at least in part to the dynamic memory's sensed temperature.

2. The system of claim 1 wherein the dynamic memory comprises a low-power synchronous dynamic random access memory.

3. The system of claim 1 wherein the adjustable refresh frequency comprises a self-refresh frequency.

4. The system of claim 1 wherein the adjustable refresh frequency comprises a distributed refresh frequency.

5. The system of claim 1 wherein the temperature sensor is integrated with the dynamic memory.

6. The system of claim 1 wherein the temperature sensor is attached to a ceramic package of the dynamic memory.

7. The system of claim 1 wherein the temperature sensor is located within several centimeters of the dynamic memory.

8. The system of claim 1 wherein the system comprises at least one of a personal digital assistant, a cellular phone, an Internet tablet, a personal computer.

9. An article comprising:
a storage medium having stored thereon instructions, that, when executed by a computing platform, result in adjusting a frequency of a refresh operation of a dynamic memory of the computing platform by:
sensing a temperature of the dynamic memory; and
adjusting the frequency of the refresh operation based at least in part on the dynamic memory's sensed temperature.

10. The article of claim 8, wherein said dynamic memory comprises a low-power synchronous dynamic random access memory.

11. The article of claim 8, wherein the temperature sensor is integrated with the dynamic memory.

12. The article of claim 8, wherein the temperature sensor is attached to a package of the dynamic memory.

13. The article of claim 8, wherein the temperature sensor is located within several centimeters of the dynamic memory.

14. The article of claim 8, wherein the computing platform comprises at least one of a personal digital assistant, a cellular phone, an Internet tablet, a personal computer.

15. The article of claim 8, wherein the refresh operation is a self-refresh operation.

16. The article of claim 8 wherein the refresh operation is a distributed refresh operation.

17. A method comprising:
sensing a temperature of a memory;
issuing a command to the memory; and
adjusting a refresh frequency of the memory based at least in part to the memory's sensed temperature.

18. The method of claim 16 wherein issuing a command comprises setting a value in an extended mode register of the memory.

19. The method of claim 16 wherein the memory is a low-power synchronous dynamic random access memory.

20. The method of claim 16 wherein sensing the temperature comprises locating a temperature sensor within zero to seven centimeters of the memory.

21. The method of claim 16 wherein sensing the temperature comprises integrating a temperature sensor with the memory.

22. The method of claim 16 wherein sensing the temperature comprises coupling a temperature sensor with a package of the memory.
